(19) United States
(12) Patent Application Publication
(10) Pub. No.: US 2005/0236018 A1
(43) Pub. Date: Oct. 27, 2005

(54) Substrate treating method and apparatus

(75) Inventor: Shuzo Nagami, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/106,313

(22) Filed: Apr. 14, 2005

(30) Foreign Application Priority Data
Apr. 27, 2004 (JP) 2004-131421

(51) Int. Cl. B08B 3/00

(52) U.S. Cl. 134/30; 134/95.3; 134/153; 134/172; 134/902

(57) ABSTRACT

A substrate treating method for performing a predetermined treatment of substrates. The method includes a step of performing chemical treatment of the substrates with a chemical, and a step of performing deionized water cleaning treatment of the substrates with superheated steam obtained by heating deionized water.

### BACKGROUND OF THE INVENTION

(1) Field of the Invention

This invention relates to substrate treating methods and apparatus for treating semiconductor wafers, glass substrates for liquid crystal displays and so on (hereinafter called simply substrates). More particularly, the invention relates to a technique for performing treatment of substrates, including chemical treatment and deionized water (pure water) cleaning treatment.

(2) Description of the Related Art

Conventionally, this type of substrate treating apparatus performs chemical treatment by loading substrates into a treating tank and supplying a chemical solution to the tank. After discharging the chemical solution, deionized water is supplied to the treating tank, and the apparatus performs deionized water cleaning treatment of the substrates immersed in the deionized water, while allowing the deionized water to overflow the tank (see Japanese Unexamined Patent Publication No. 11-162921 (1999), for example).

The conventional apparatus noted above has the following drawbacks.

The conventional apparatus requires a long time to remove the chemical solution adhering to the substrates, and must therefore supply a large quantity of deionized water. Thus, the conventional apparatus has a drawback of consuming a large quantity of deionized water. The deionized water cleaning treatment must always be followed by drying treatment in order to dry the substrates wet with the deionized water. This results in an increased number of treating steps.

### SUMMARY OF THE INVENTION

This invention has been made having regard to the state of the art noted above, and its object is to provide a substrate treating method and apparatus for performing improved deionized water cleaning treatment to reduce the consumption of deionized water, and simultaneously performing drying treatment to reduce the number of treating steps.

To fulfill the above object, Inventor has made intensive research and attained the following findings.

It has been found that the deionized water cleaning treatment performed after chemical treatment requires a long time because water flows are hampered by boundary films formed adjacent the substrate surfaces. That is, the boundary films worsen the intimacy between substrate surfaces and deionized water, and it takes time to replace the chemical solution on the substrate surfaces with deionized water. This results in an extended time consumed in cleaning the substrates with deionized water.

Based on the above findings, this invention provides a substrate treating method comprising the steps of performing chemical treatment of the substrates with a chemical, and performing deionized water cleaning treatment of the substrates with superheated steam obtained by heating deionized water.

According to this invention, the superheated steam is used in time of deionized water cleaning treatment. The superheated steam is obtained by heating steam above the boiling point, and has the characteristics that it is at a temperature higher than that of saturated steam, and that it does not condense when cools to some degree. Since steam has a very low cohesive strength compared with liquid, and can therefore reduce boundary films occurring adjacent substrate surfaces. Thus, by supplying the hot, superheated steam, the chemical adhering to the substrate surfaces may be replaced efficiently to clean the substrates. Further, by using superheated steam, consumption may be drastically reduced compared with the case of cleaning with deionized water. Since superheated steam is high in temperature and low in humidity compared with deionized water, the substrate can be dried at the same time. As a result, the treatment may be carried out with a reduced number of steps while reducing the consumption of deionized water.

The deionized water cleaning treatment may be a final deionized water cleaning treatment.

Since drying treatment may be carried out at the same time, the final deionized water cleaning treatment is most suitable among a series of treatments including the chemical treatment and deionized water cleaning treatment.

Preferably, the superheated steam is in a temperature range of 100 to 180° C.

Since the boiling point of deionized water is 100° C., it is appropriate to generate superheated steam ranging from 100 to 180° C. which does not impose an excessive heating load. A temperature range of 160 to 170° C. is more desirable. Such a temperature range can hold down the load of overheating while producing the same effect irrespective of steam humidity.

In another aspect of the invention, a substrate treating apparatus comprises a treating tank for storing a chemical solution, a holding mechanism for holding the substrates in the treating tank, a chemical supply line for supplying the chemical solution to the treating tank, a superheated steam supply line for supplying the substrates with superheated steam obtained by heating deionized water, and a moving mechanism for moving, relative to each other, a surface of the chemical solution in the treating tank and the substrates held by the holding mechanism, wherein, after performing chemical treatment of the substrates with the chemical solution in the treating tank, the moving mechanism is operated to move, relative to each other, the surface of the chemical solution in the treating tank and the substrates held by the holding mechanism, and the superheated steam supply line is operated to supply the superheated steam to the substrates.

Chemical treatment of the substrates is performed by supplying a chemical solution from the chemical supply line to the treating tank in which the substrates are held by the holding mechanism. Thereafter deionized water cleaning treatment is performed by operating the moving mechanism to move the substrates relative to the surface of the chemical solution, and supplying superheated steam from the super-heated steam supply line. Thus, the hot, superheated steam can act on the substrates efficiently, to replace the chemical solution adhering to the substrate surfaces and clean the substrates. Further, by using superheated steam, consumption may be drastically reduced compared with the case of cleaning with deionized water. Since superheated steam is high in temperature and low in humidity, the substrates can be dried at the same time. As a result, the treatment may be carried out with a reduced number of steps while reducing the consumption of deionized water.

Preferably, the superheated steam supply line is arranged to supply the superheated steam to the substrates held by the holding mechanism in the treating tank, and the moving mechanism has a discharge mechanism for discharging the chemical solution stored in the treating tank from the treating tank.

Since the superheated steam supply line supplies the superheated steam into the treating tank, the superheated steam is prevented from leaking to the ambient, to act on the substrates efficiently. Further, the substrates are moved with the discharge mechanism lowering the surface of the chemical solution, which is a simple operation for moving the substrates.

In a further aspect of the invention, a substrate treating apparatus comprises a holding mechanism for holding a substrate in the treating tank, a drive mechanism for spinning the holding mechanism, a chemical supply line for supplying a chemical to the substrate held by and spinning with the holding mechanism, and a superheated steam supply line for supplying superheated steam obtained by heating deionized water, to the substrate held by and spinning with the holding mechanism, after chemical treatment of the substrate with the chemical supplied from the chemical supply line to the substrate,

After chemical treatment performed by supplying a chemical from the chemical supply line, deionized water cleaning treatment is performed by supplying superheated steam from the superheated steam supply line to the substrate held by and spinning with the holding mechanism. Thus, the hot, superheated steam can act on the substrates efficiently, to replace the chemical adhering to the substrate surfaces and clean the substrates. Further, by using superheated steam, consumption may be drastically reduced compared with the case of cleaning with deionized water. Since superheated steam is high in temperature and low in humidity, the substrates can be dried at the same time. As a result, the treatment may be carried out with a reduced number of steps while reducing the consumption of deionized water.

Preferably, the superheated steam supply line is arranged to supply the superheated steam to the substrates in a final deionized water cleaning treatment, and is arranged to heat the steam to a temperature range of 100 to 180° C.

The holding mechanism may include a heater for heating the holding mechanism, and support pins extendible and retractable relative to the holding mechanism, the support pins being extended when the superheated steam is supplied from the superheated steam supply line.

By heating the holding mechanism with the heater beforehand, the superheated steam is prevented from condensing into dew drops through contact with the holding mechanism and adversely affecting the substrate. Further, by extending the support pins, the substrate may be moved apart from the holding mechanism having a large heat capacity. This is also effective to prevent the superheated steam from condensing into dew drops on the substrate.

The superheated steam supply line may include a gas source, the superheated steam supply line supplying a gas before supplying the superheated steam.

Even when dew drops are formed in piping of the superheated steam supply line, cleaning and drying treatments may be carried out by supplying the superheated steam after discharging the dew drops by supplying the gas from the superheated steam supply line. The piping, preferably, includes a heater upstream of a delivery opening for heating the gas from the gas source for delivery.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a block diagram showing an outline of a substrate treating apparatus according to Embodiment 1;

FIG. 2 is an explanatory view showing operation of the substrate treating apparatus;

FIG. 3 is an explanatory view showing operation of the substrate treating apparatus;

FIG. 4 is an explanatory view showing operation of the substrate treating apparatus;

FIG. 5 is an explanatory view showing operation of the substrate treating apparatus;

FIG. 6 is a block diagram showing an outline of a substrate treating apparatus according to Embodiment 2;

FIG. 7 is an explanatory view showing operation of the substrate treating apparatus;

FIG. 8 is an explanatory view showing operation of the substrate treating apparatus;

FIG. 9 is an explanatory view showing operation of the substrate treating apparatus; and

FIG. 10 is a block diagram showing an outline of a modified substrate treating apparatus.

### DESCRIPTION OF THE PREFERRED EMBODIMENTS

Preferred embodiments of this invention will be described in detail hereinafter with reference to the drawings.

### Embodiment 1

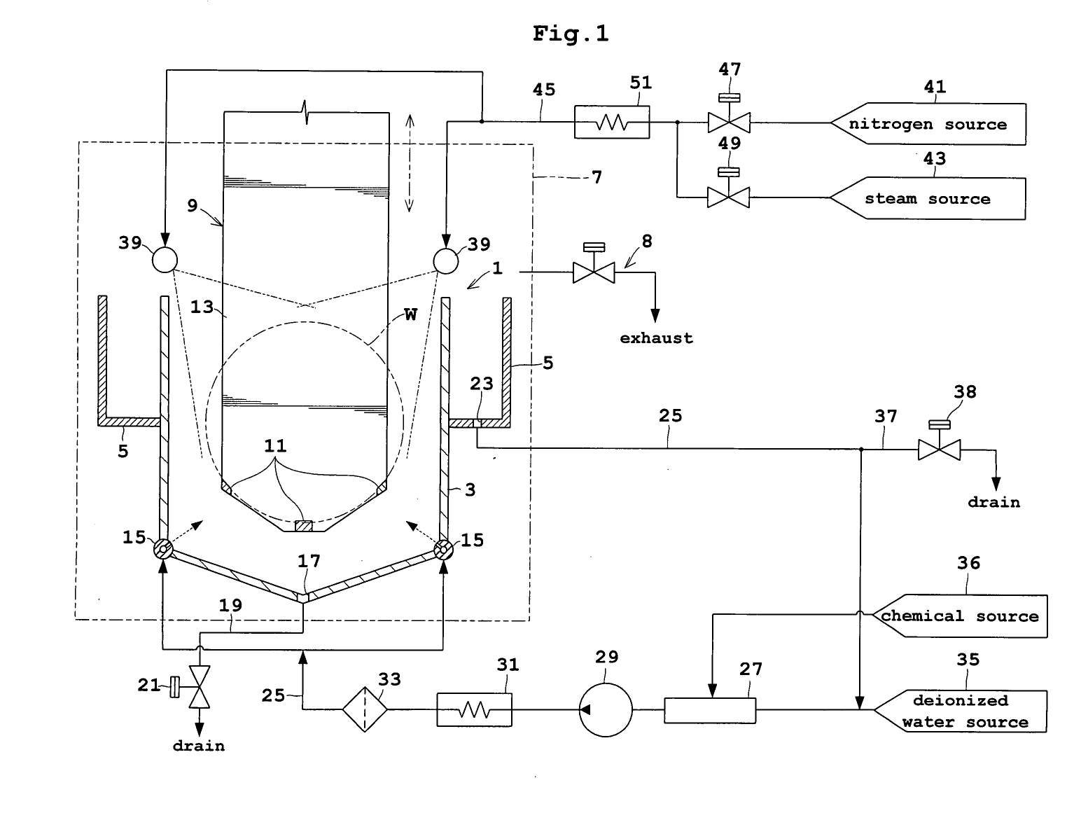

FIG. 1 is a block diagram showing an outline of a substrate treating apparatus according to Embodiment 1.

A treating tank 1 for treating wafers W includes an inner tank 3 and an outer tank 5. The treating tank 1 as a whole is enclosed in a chamber 7. The chamber 7 has a transport opening, not shown, in an upper position thereof for allowing passage of the wafers W into and out of the chamber 7, and an exhaust mechanism 8 with piping and a switch valve for discharging internal gas. The inner tank 3 accommodates a plurality of wafers W as held by a lifter 9, and treats the wafers W with a chemical solution and so on. The lifter 9 includes a three-piece support member 11 extending from lower positions of a back plate 13 for contacting and supporting lower edges of wafers W. The lifter 9 depicted in FIG. 1 is in a treating position inside the inner tank 3, and is vertically movable between this treating position and a standby position above the chamber 7.

The inner tank 3 includes filling pipes 15 arranged at opposite sides in the bottom thereof for supplying treating solutions including a chemical solution to the inner tank 3, and a drain port 17 disposed between the filling pipes 15. The drain port 17 is in communication with a drain pipe 19 having a switch valve 21 mounted thereon. The outer tank 5 includes a drain port 23 for draining the chemical solution and the like overflowing the inner tank 3 and collecting in the outer tank 5. The drain port 23 communicates with the filling pipes 15 through supply piping 25.

The supply piping 25 corresponding to the chemical supply line includes a mixing valve 27, a pump 29, an in-line heater 31 and a filter 33 arranged in order from upstream to downstream. A deionized water source 35 is connected to an upstream end of the mixing valve 27, while a chemical source 36 is connected to an input side of the mixing valve 27. The chemical source 36 supplies the mixing valve 27 with hydrofluoric acid (HF), for example. The mixing valve 27 mixes the chemical into deionized water from the deionized water source 35, and the resulting solution is transmitted under pressure by the pump 29 through the supply piping 25. A branch pipe 37 for draining purposes is connected to the supply piping 25 adjacent the drain port 23, and a switch valve 38 is mounted on the branch pipe 37.

Supply nozzles 39 forming part of the superheated vapor supply line of this invention are arranged above upper edges of the inner tank 3. The supply nozzles 39 are in communication with piping 45 connected to a nitrogen source 41 and a steam source 43. The piping 45 includes a switch valve 47 for controlling the supply of nitrogen, and a switch valve 49 for controlling the supply of superheated steam. The piping 45 further includes a heater 51 disposed downstream of these switch valves 47 and 49.

The nitrogen source 41 supplies what is called dry nitrogen (dry N₂) as nitrogen, which may be preheated nitrogen (hot N₂). The steam source 43 supplies superheated steam produced by superheating deionized water (pure water). The steam source 43 may include a steam producing unit for producing steam from deionized water, and a heater for heating the steam from the steam producing unit above the boiling point of deionized water to produce superheated steam, or may include a superheated steam producing unit for producing superheated steam straight from deionized water by means of a heater. The “superheated steam” is obtained by heating steam above the boiling point, and has characteristics that it is at a temperature higher than that of saturated steam, and that it does not condense when cools to some degree. Its preferred temperature is in a range of 100 to 180° C., for example. Since the boiling point of deionized water is 100° C., it is appropriate to generate superheated steam ranging from 100 to 180° C. which does not impose an excessive heating load. A temperature range of 160 to 170° C. is more desirable. Such a temperature range can hold down the load of overheating while producing the same effect irrespective of steam humidity.

The heater 51 is used to reheat the dry nitrogen outputted from the nitrogen source 41 to the supply nozzles 39, and to reheat the superheated steam outputted from the steam source 43. However, it is not necessary to provide the heater 51 where no sharp fall occurs to the temperatures of the gases outputted from the respective sources 41 and 43.

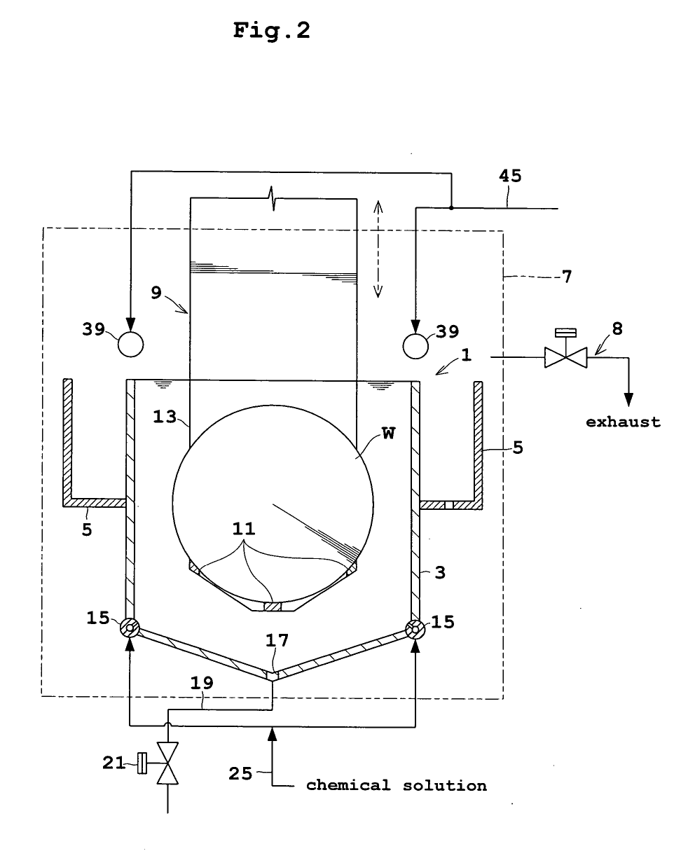

Next, operation of the substrate treating apparatus having the above construction will be described with reference to FIGS. 2 through 5. FIGS. 2 through 5 are explanatory views showing operation of the substrate treating apparatus. Preferably, before the treatment described hereinafter, the switch valve 47 is opened and the exhaust mechanism 8 operated to purge gas from the chamber 7 with hot nitrogen.

In the mixing valve 27 the chemical is mixed into the deionized water supplied from the deionized water source 35. The treating solution thereby formed is heated to a predetermined temperature at the in-line heater 31, while being transmitted under pressure by the pump 29, to be supplied to the inner tank 3. When the inner tank 3 is filled with the treating solution, its supply is once suspended. A plurality of wafers W to be treated are moved, as held in upstanding posture by the lifter 9, to the treating position in the inner tank 3 as shown in FIG. 2.

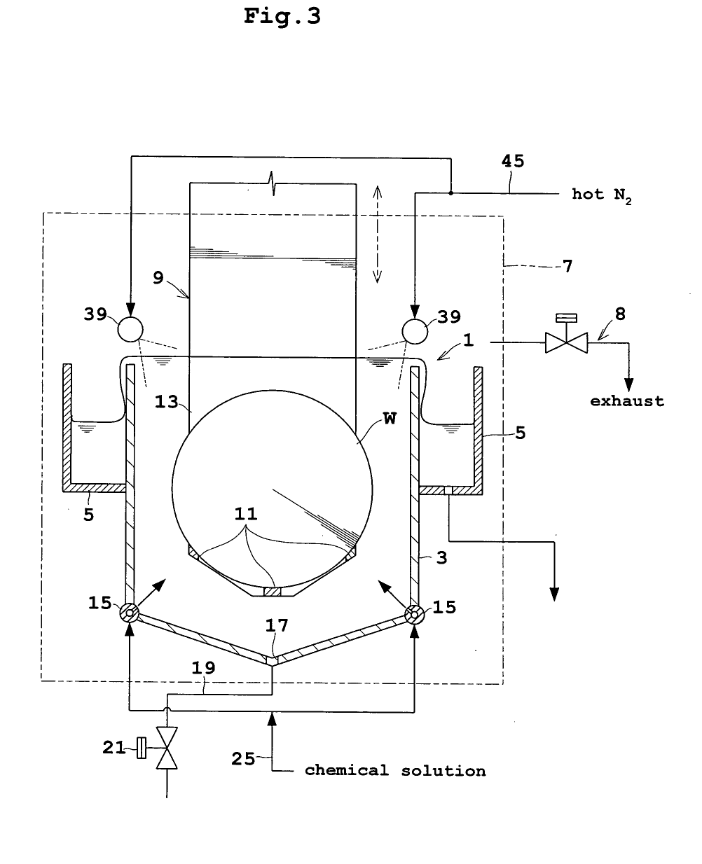

Next, as shown in FIG. 3, the supply of the treating solution is resumed to treat the wafers W while causing the treating solution to overflow the inner tank 3 to be collected by the outer tank 5 and recirculated through the supply piping 25. This state is maintained for a predetermined time to carry out chemical treatment of the wafers W. When the chemical treatment for the predetermined time finishes, the pump 29 is first stopped to stop the supply of the treating solution. Then, the switch valve 47 is opened and the heater 51 is operated to supply hot nitrogen from the supply nozzles 39 into the inner tank 3. Superheated steam is supplied next, which is an operation for discharging beforehand any dew drops adhering to the piping 45 and supply nozzles 39. This operation is unnecessary where there is no possibility of such dew drops being formed.

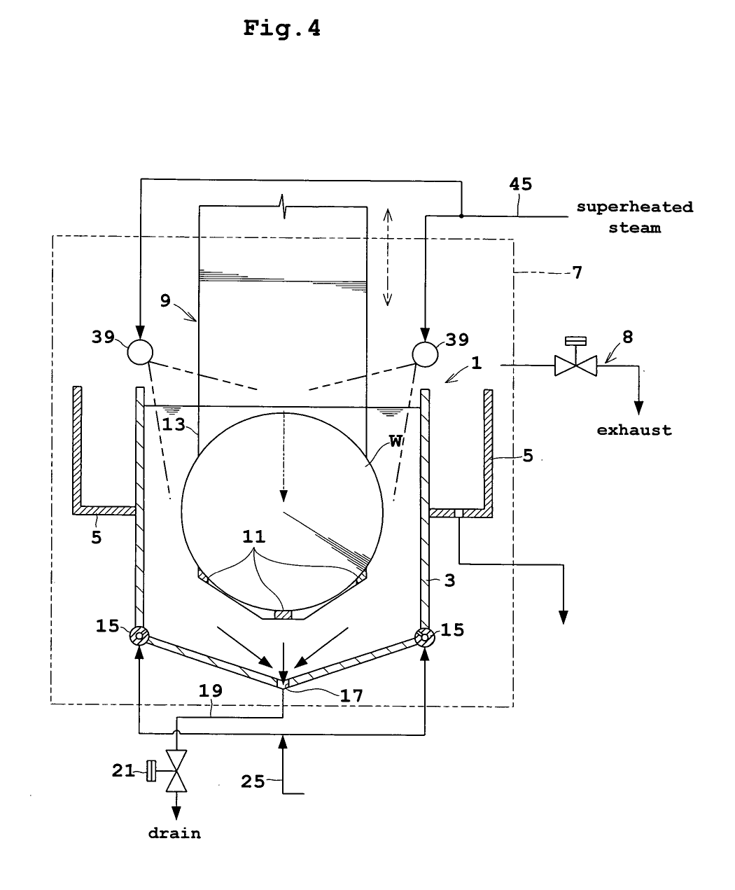

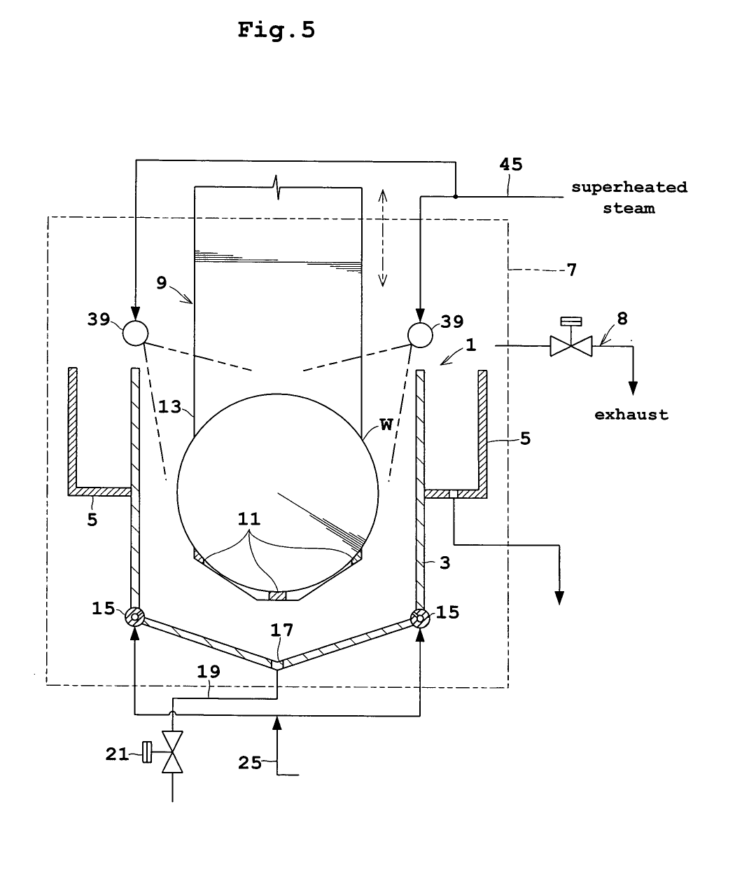

Upon completion of the chemical treatment with the treating solution described above, as shown in FIG. 4, the switch valve 21 is opened to drain the treating solution in the inner tank 3 from the drain port 17, with the switch valve 47 closed and the switch valve 49 opened. As a result, the treating solution gradually subsides in the inner tank 3, and the wafers W emerge gradually, upper edges first. Superheated steam is then supplied to the exposed wafers W, whereby the treating solution adhering to the wafers W is replaced and removed by the superheated steam. This state is continued until the treating solution is thoroughly discharged from the drain port 17 of the inner tank 3 as shown in FIG. 5, and is maintained for a predetermined time by way of drying treatment. Further, the switch valve 49 is closed, and the switch valve 47 is opened to supply hot nitrogen. Subsequently, the lifter 9 is raised to the standby position to withdraw the wafers W from the chamber 7. Through the above series of processes, the wafers W can receive treatments including chemical treatment, deionized water cleaning treatment and drying treatment.

After performing the chemical treatment of the wafers W by supplying the chemical solution from the supply piping 25 into the treating tank 1, deionized water cleaning treatment is performed for the wafers W by supplying super-heated steam from the supply nozzles 39 into the treating tank 1 enclosed in the chamber 7. By supplying super-heated steam to the treating tank 1 enclosed in the chamber 7, the superheated steam can act on the wafers W efficiently without leaking to the ambient. Thus, the hot, superheated steam acts on the wafers W efficiently, and cleans the wafers W by removing the chemical solution adhering to the surfaces thereof. By using superheated steam, consumption may be drastically reduced compared with the case of cleaning directly with deionized water. Since superheated steam is high in temperature and low in humidity, the wafers W can be dried at the same time. As a result, this treatment may be carried out with a reduced number of steps while reducing the consumption of deionized water.

### Embodiment 2

Next, Embodiment 2 of this invention will be described with reference to the drawings.

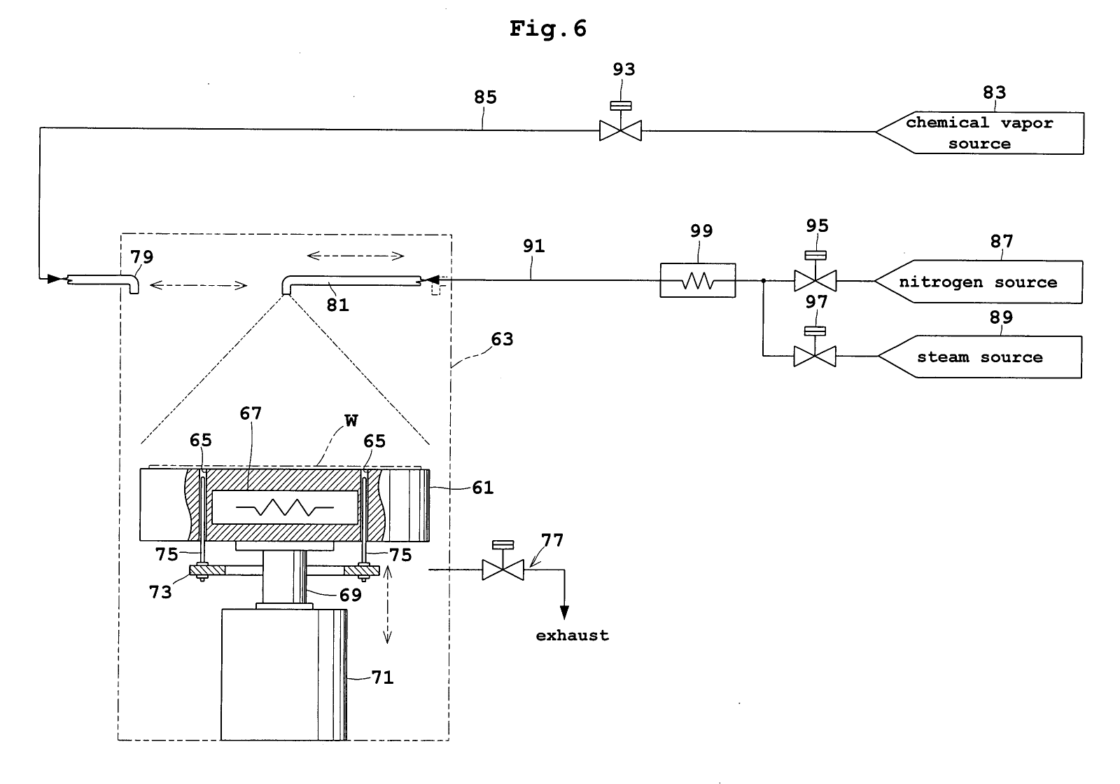

FIG. 6 is a block diagram showing an outline of a substrate treating apparatus according to Embodiment 2.

The substrate treating apparatus in Embodiment 1 described above is what is called the “batch type” that treats a plurality of wafers W at once. The substrate treating apparatus in this embodiment is different, and is what is called the “single-substrate type” that treats one wafer W at a time.

This apparatus includes a holding mechanism 61 for supporting a wafer W in horizontal posture, and a chamber 63 surrounding the holding mechanism 61. The holding mechanism 61 includes a member having an outside diameter slightly larger than the outside diameter of wafer W. This member has through holes 65 formed in positions corresponding to vertices of its equilateral triangular shape in plan view. The holding mechanism 61 further includes a heater 67 mounted therein for heating the holding mechanism 61 to a predetermined temperature. The heater 67 provides a heating to about 40° C., for example. The holding mechanism 61 has one end of a rotary shaft 69 connected to the bottom thereof, the other end of the shaft 69 being connected to a rotary shaft of a rotary motor 71.

An annular member 73 is disposed above the rotary motor 71 to be vertically movable by a lift mechanism not shown. The annular member 73 has support pins 75 erected in positions on an upper surface thereof corresponding to the through holes 65. The support pins 75 are vertically movable with the annular member 73 between a standby position where upper ends of the pins 75 are retracted from the upper surface of the holding mechanism 61 as shown in the FIG. 6, and a transfer position where the upper ends of the pins 75 project from the upper surface of the holding mechanism 61. The support pins 75 are also revolvable with the holding mechanism 61.

The chamber 63 includes an exhaust mechanism 77 for discharging internal gas therefrom. The chamber 63 further includes a chemical supply nozzle 79 and a steam supply nozzle 81 arranged above the holding mechanism 61. Each of the nozzles 79 and 81 is movable between a standby position adjacent a side wall of the chamber 63 and a treating position over the holding mechanism 61.

The chemical supply nozzle 79 is connected to piping 85 connected to a chemical vapor source 83 for supplying a vapor of hydrofluoric acid (HF), for example. The steam supply nozzle 81 is connected to piping 91 communicating with a nitrogen source 87 and a steam source 89. The piping 85 includes a switch valve 93 for controlling the supply of the chemical vapor. The piping 91 includes a switch valve 95 for controlling the supply of dry nitrogen, and a switch valve 97 for controlling the supply of superheated steam. The piping 91 includes also a heater 99 for reheating the dry nitrogen supplied from the nitrogen source 87 and the superheated steam supplied from the steam source 89. The steam source 89 supplies superheated steam in the temperature range described in Embodiment 1.

The chemical supply nozzle 79 corresponds to the chemical supply line in this invention. The steam supply nozzle 81 corresponds to the superheated steam supply line in this invention.

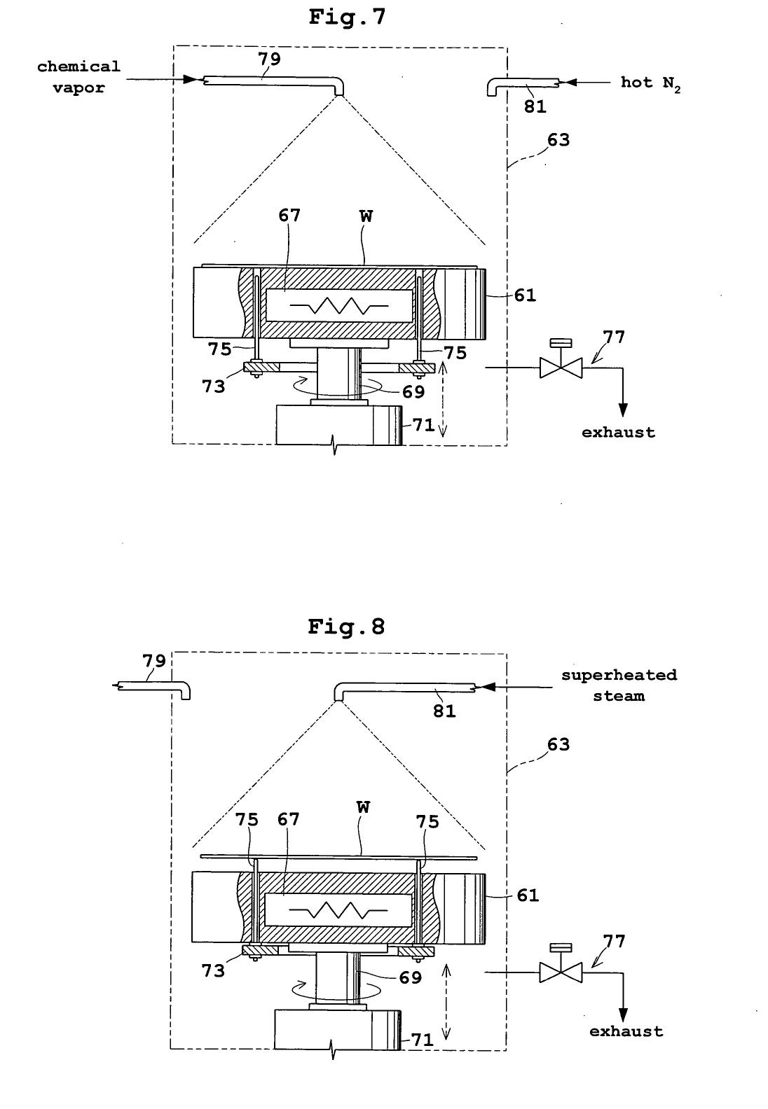

Next, operation of the substrate treating apparatus having the above construction will be described with reference to FIGS. 7 through 9. FIGS. 7 through 9 are explanatory views showing operation of the substrate treating apparatus. Preferably, before the treatment described hereinafter, the switch valve 95 is opened and the exhaust mechanism 77 operated to purge gas from chamber 63 with hot nitrogen.

The support pins 75 are first raised to receive a wafer W from a transport device not shown. Then, the support pins 75 are lowered to place the wafer W on the holding mechanism 61. The rotary motor 71 is rotated at a constant speed (FIG. 7). The number of rotations at this time is 50 to 300 rpm, for example. The chemical supply nozzle 79 is advanced to the treating position, and the switch valve 93 is opened to supply the chemical vapor (e.g. a vapor of hydrofluoric acid HF) from the chemical vapor source 83 over the entire upper surface of wafer W. Before supplying the chemical vapor, the heater 67 may be operated to maintain the wafer W and holding mechanism 61 at a predetermined temperature. The vapor supplying state is maintained for a predetermined time to carry out chemical treatment of the wafer W. During the chemical treatment, the switch valve 95 may be kept open to continue introducing hot nitrogen into the chamber 63 to purge the internal gas therefrom. It is preferable to supply hot nitrogen at least before supplying superheated steam as a next step, to discharge dew drops from the piping 91 and steam supply nozzle 81. The dew drops are discharged through an area laterally of the holding mechanism 61 without adversely affecting the wafer W. The dew drops, even if they should contact the wafer W, the on-going treatment with the chemical vapor would prevent the dew drops from affecting the wafer W to a serious degree.

Next, the support pins 75 are raised to move the wafer W apart from the holding mechanism 61. The switch valve 93 is closed, and the chemical supply nozzle 79 is returned to the standby position. The steam supply nozzle 81 is advanced to the treating position, the switch valve 95 is closed, and the switch valve 97 is opened (FIG. 8). As a result, superheated steam is supplied to the upper surface of wafer W to remove the chemical from the upper surface, thereby effecting deionized water cleaning treatment and drying treatment. The wafer W is maintained apart from the holding mechanism 61 at this time in order to avoid the heat of the superheated steam being taken away by the holding mechanism 61 having a large heat capacity, which would result in condensation on the wafer W. It is therefore unnecessary to keep the wafer W apart when the wafer W is heated to 100° C. or higher by the heater 67 to be unsusceptible to condensation. The number of rotations at this time may be the same as that noted above, but should preferably be 50 to 200 rpm, for example, to ensure stability of the wafer W remaining apart from the holding mechanism 61.

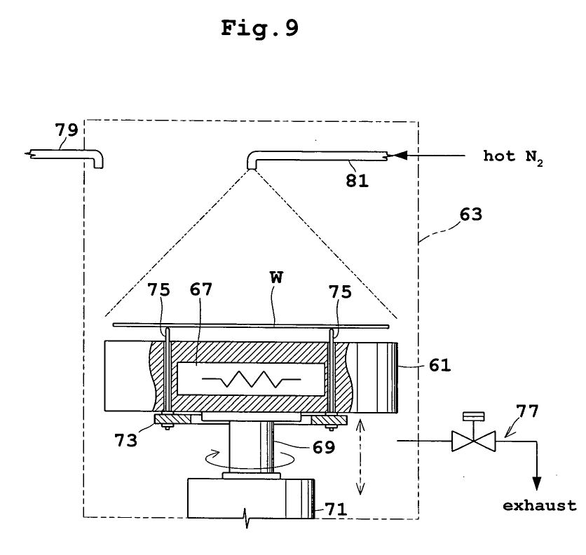

After performing the treatment with the superheated vapor for a fixed time as described above, the switch valve 97 is closed and the switch valve 95 opened to supply hot nitrogen to the wafer W for a fixed time as shown in FIG. 9, to complete the treatment. Subsequently, the rotary motor 71 is stopped, and the switch valve 95 is closed to stop the supply of hot nitrogen. After retracting the steam supply nozzle 81 to the standby position, the wafer W raised by the support pins 75 is unloaded from the apparatus.

After the chemical treatment with the chemical vapor supplied from the chemical supply nozzle 79 as described above, deionized water cleaning treatment is performed by supplying superheated steam from the steam supply nozzles 81 to the holding mechanism 61 enclosed in the chamber 63. By supplying superheated steam to the holding mechanism 61 enclosed in the chamber 63, the superheated steam can act on the wafer W efficiently without leaking to the ambient. Thus, the hot, superheated steam acts on the wafer W efficienctly, and cleans the wafer W by removing the chemical adhering to the surface thereof. By using superheated steam, consumption may be drastically reduced compared with the case of cleaning directly with deionized water. Since superheated steam is high in temperature and low in humidity, the wafer W can be dried at the same time. As a result, this treatment may be carried out with a reduced number of steps while reducing the consumption of deionized water.

<Modification>

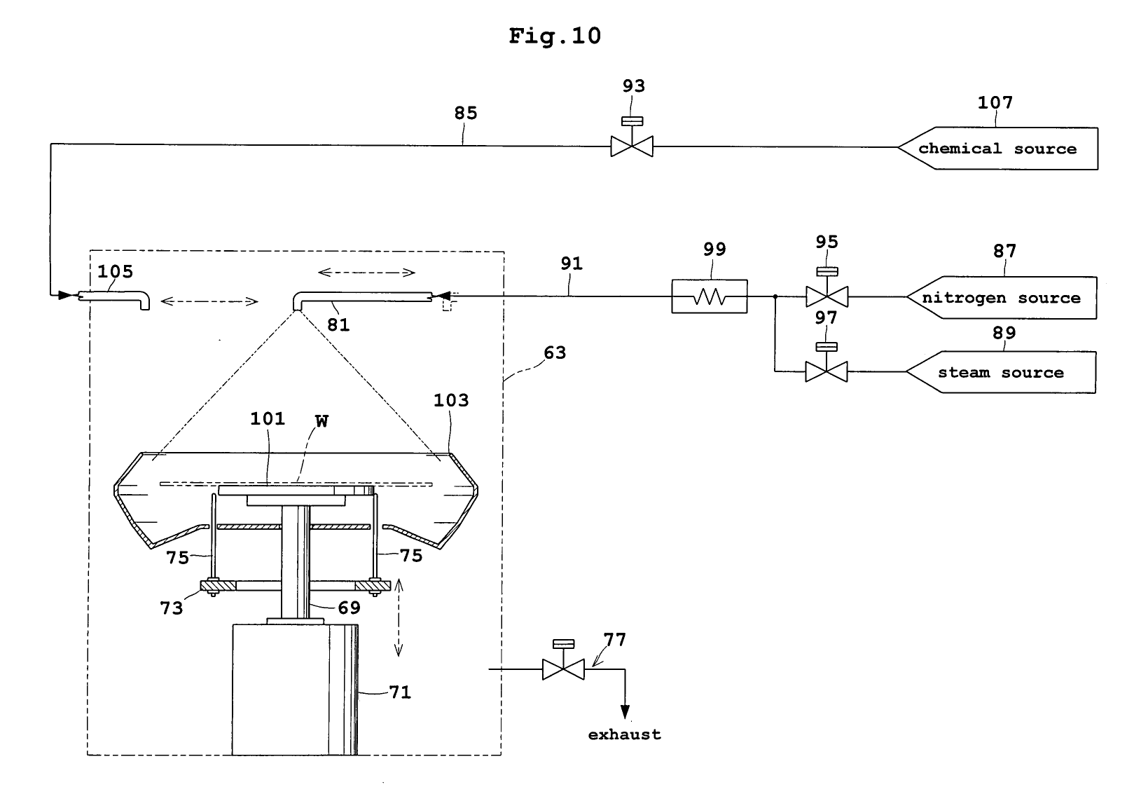

A modification of Embodiment 2 above will be described with reference to FIG. 10.

The apparatus in Embodiment 2 described above is constructed to perform chemical treatment by supplying a chemical vapor. This modified apparatus has a construction for supplying a chemical in liquid state instead of vapor. Like reference numerals are used to identify like parts in the foregoing construction which will not be described again

A holding mechanism 101 for holding a wafer W includes a disk-shaped member of smaller diameter than the wafer W. The holding mechanism 101 is surrounded by a scatter preventive cup 103. A chemical supply nozzle 105 is disposed above the holding mechanism 101, and is connected through piping 85 to a chemical source 107. The chemical source 107 supplies a chemical in liquid state.

The substrate treating apparatus having such a construction performs chemical treatment by supplying the chemical in liquid state from the chemical source 107, while spinning the wafer W to scatter the chemical around by centrifugal force. The scattering chemical is collected by the scatter preventive cup 103. A subsequent deionized water cleaning treatment may be carried out as with the apparatus described hereinbefore. That is, the wafer W is raised by the support pins 75, and superheated steam is supplied to the wafer W. This construction for supplying the chemical in liquid state to the wafer W produces the same effect as in Embodiment 2.

This invention is not limited to the foregoing embodiments, but may be modified as follows:

(1) In each embodiment described above, chemical treatment is performed by supplying hydrofluoric acid (HF) as a chemical. The following chemicals may also be used in the treatment:
SC1 (mixture of ammonia, hydrogen peroxide solution and deionized water);
SC2 (mixture of chloride, hydrogen peroxide solution and deionized water);
SPM (mixture of sulfuric acid and hydrogen peroxide solution);
BHF (buffer hydrofluoric acid solution); and
phosphoric acid (H₃PO₄).

(2) While the foregoing embodiments have been described by taking circular wafers W for example, this invention is applicable also to square substrates.

(3) All of the foregoing embodiments include chambers. Such chambers are dispensable where, for example, a construction is provided for applying gentle downflows to the substrates, along with a construction for allowing no leakage to the ambient of superheated steam flowing from above to below the substrates.

(4) In the foregoing embodiments, superheated steam is used in the final deionized water cleaning and drying treatment. Such superheated steam may be used in a non-final deionized water cleaning treatment also.

This invention may be embodied in other specific forms without departing from the spirit or essential attributes thereof and, accordingly, reference should be made to the appended claims, rather than to the foregoing specification, as indicating the scope of the invention.

1. A substrate treating method comprising the steps of:
performing chemical treatment of the substrates with a chemical; and
performing deionized water cleaning treatment of the substrates with superheated steam obtained by heating deionized water.

2. A method as defined in claim 1, wherein said deionized water cleaning treatment is a final deionized water cleaning treatment.

3. A method as defined in claim 1, wherein said super-heated steam is in a temperature range of 100 to 180° C.

4. A method as defined in claim 2, wherein said super-heated steam is in a temperature range of 100 to 180° C.

5. A substrate treating apparatus comprising:
a treating tank for storing a chemical solution;
a holding mechanism for holding the substrates in said treating tank;
a chemical supply line for supplying the chemical solution to said treating tank;
a superheated steam supply line for supplying the substrates with superheated steam obtained by heating deionized water; and
a moving mechanism for moving, relative to each other, a surface of the chemical solution in said treating tank and the substrates held by said holding mechanism;
wherein, after performing chemical treatment of the substrates with the chemical solution in said treating tank, said moving mechanism is operated to move, relative to each other, the surface of the chemical solution in said treating tank and the substrates held by said holding mechanism, and said superheated steam supply line is operated to supply the superheated steam to the substrates.

6. An apparatus as defined in claim 5, wherein said super-heated steam supply line is arranged to supply the super-heated steam to the substrates held by said holding mechanism in said treating tank, and said moving mechanism has a discharge mechanism for discharging the chemical solution stored in said treating tank from said treating tank.

7. A substrate treating apparatus comprising:
a holding mechanism for holding a substrate in said treating tank;
a drive mechanism for spinning said holding mechanism;
a chemical supply line for supplying a chemical to the substrate held by and spinning with said holding mechanism; and
a superheated steam supply line for supplying super-heated steam obtained by heating deionized water, to the substrate held by and spinning with said holding mechanism, after chemical treatment of the substrate with the chemical supplied from said chemical supply line to the substrate,

8. An apparatus as defined in claim 5, wherein said super-heated steam supply line is arranged to supply the super-heated steam to the substrates in a final deionized water cleaning treatment.

9. An apparatus as defined in claim 6, wherein said super-heated steam supply line is arranged to supply the super-heated steam to the substrates in a final deionized water cleaning treatment.

10. An apparatus as defined in claim 7, wherein said super-heated steam supply line is arranged to supply the super-heated steam to the substrate in a final deionized water cleaning treatment.

11. An apparatus as defined in claim 7, wherein said super-heated steam supply line is arranged to heat the steam to a temperature range of 100 to 180° C.

12. An apparatus as defined in the claim 6, wherein said holding mechanism includes a heater for heating the holding mechanism, and support pins extendible and retractable relative to said holding mechanism, said support pins being extended when the superheated steam is supplied from said superheated steam supply line.

13. An apparatus as defined in the claim 7, wherein said holding mechanism includes a heater for heating the holding mechanism, and support pins extendible and retractable relative to said holding mechanism, said support pins being extended when the superheated steam is supplied from said superheated steam supply line.

14. An apparatus as defined in the claim 8, wherein said holding mechanism includes a heater for heating the holding mechanism, and support pins extendible and retractable relative to said holding mechanism, said support pins being extended when the superheated steam is supplied from said superheated steam supply line.

15. An apparatus as defined in the claim 9, wherein said holding mechanism includes a heater for heating the holding mechanism, and support pins extendible and retractable relative to said holding mechanism, said support pins being extended when the superheated steam is supplied from said superheated steam supply line.

16. An apparatus as defined in the claim 10, wherein said holding mechanism includes a heater for heating the holding mechanism, and support pins extendible and retractable relative to said holding mechanism, said support pins being extended when the superheated steam is supplied from said superheated steam supply line.

17. An apparatus as defined in claim 5, wherein said super-heated steam supply line includes a gas source, said super-heated steam supply line supplying a gas before supplying the superheated steam.

18. An apparatus as defined in claim 6, wherein said super-heated steam supply line includes a gas source, said super-heated steam supply line supplying a gas before supplying the superheated steam.

19. An apparatus as defined in claim 7, wherein said super-heated steam supply line includes a gas source, said super-heated steam supply line supplying a gas before supplying the superheated steam.

20. An apparatus as defined in claim 8, wherein said super-heated steam supply line includes a gas source, said super-heated steam supply line supplying a gas before supplying the superheated steam.
